(19) United States
(12) Patent Application Publication
(10) Pub. No.: US 2021/0246851 A1
(43) Pub. Date: Aug. 12, 2021

(54) FUEL SUPPLY FOR AN INTERNAL COMBUSTION ENGINE

(71) Applicant: Mahle International GmbH, Stuttgart (DE)

(72) Inventors: Thomas Ehlert, Boeblingen (DE); Martin Hein, Stuttgart (DE); Markus Preissinger, Leonberg (DE); Simon Streng, Stuttgart (DE)

(21) Appl. No.: 17/052,797

(22) PCT Filed: Mar. 14, 2019
(86) PCT No.: PCT/EP2019/056470

§ 371 Date: Nov. 3, 2020

(30) Foreign Application Priority Data
May 4, 2018 (DE) 10 2018 206 970.0

(51) Int. Cl. F02M 25/08; B60K 15/035

(52) U.S. Cl. CPC F02M 25/0854; B01D 71/021; B60K 15/03504

(57) ABSTRACT

A fuel supply system for an internal combustion engine includes a fuel tank and an air supply and venting device for the fuel tank. The air supply and venting device includes a hydrocarbon retention device and an air supply and venting path, structured and arranged to provide a gas exchange between the fuel tank and an environment. The hydrocarbon retention device includes at least one filter membrane that separates hydrocarbons from air. The at least one filter membrane is arranged in the air supply and venting path such that the air supply and venting path is covered by the at least one filter membrane to prevent hydrocarbons from escaping from the fuel tank into the environment through the air supply and venting path. The at least one filter membrane has hydrocarbon nanotubes.

### CROSS-REFERENCE TO RELATED APPLICATIONS

This application claims priority to International Patent Application No. PCT/EP2019/056470 filed Mar. 14, 2019, which claims priority to German Patent Application DE 10 2018 206 970.0 filed May 4, 2018, the contents of each of which is hereby incorporated by reference it its entirety.

### TECHNICAL FIELD

The invention relates to a fuel supply system for an internal combustion engine of a motor vehicle comprising a fuel tank and comprising an air supply and venting device for the fuel tank, wherein the air supply and venting device has a hydrocarbon retention device.

### BACKGROUND

Hydrocarbon retention devices of this type are necessary in order to prevent that hydrocarbons, which essentially form the propellant or fuel, respectively, for the internal combustion engine, escape into the environment. A pressure compensation with respect to the environment is necessary because it is otherwise difficult to remove the fuel from the tank or to fill the tank with fuel again. The heat expansions caused by temperature fluctuations are also compensated with the help of the air supply and venting device.

Known air supply and venting devices often have activated carbon filters, which represent the hydrocarbon retention device. These activated carbon filters adsorb the hydrocarbons. If this gas is guided through the activated carbon filter in response to a pressure compensation, thus gas escape from the fuel tank into the environment, the hydrocarbons are adsorbed in the activated carbon, so that they do not escape into the environment.

However, these hydrocarbon retention devices, which operate with activated carbon filters, are technically highly complex because these activated carbon filters have to be regenerated. In addition, there is a balance between adsorption and desorption of the hydrocarbons at the activated carbon. As a result, it is never possible to retain all of the hydrocarbons.

### SUMMARY

The invention is based on the object of providing an improved or at least different embodiment of a fuel supply system, which is characterized in particular by a hydrocarbon retention device with a simpler design.

According to the invention, this object is solved by means of the subject matters of the independent claims. Advantageous further developments are subject matter of the dependent claims.

The invention is based on the basic idea of replacing the technically complex activated carbon filters by a simple membrane system, in order to form the hydrocarbon retention device from this. According to the invention it is thus provided that the air supply and venting device has an air supply and venting path, via which a gas exchange between the fuel tank and an environment is possible. The pressure compensation when filling or emptying the fuel tank can thus be made possible. It is further provided according to the invention that the hydrocarbon retention device has at least one filter membrane, which can separate hydrocarbons from air. This filter membrane provides for the selective retention of the hydrocarbons, while air, in particular oxygen, nitrogen, and CO2, can escape from the fuel tank into the environment and vice versa, and thus provides for a pressure compensation. For this purpose it is further provided according to the invention that the filter membrane is arranged in the air supply and venting path of the fuel tank in such a way that the air supply and venting path is covered by the filter membrane, and as a result hydrocarbons are prevented from escaping from the fuel tank into the environment through the air supply and venting path. The filter membrane thus blocks the path between tank content and environment for hydrocarbons, while the components of air can pass through the membrane. A very simple, installation space-optimized, and effective hydrocarbon retention device is made possible in this way. In particular a hydrocarbon retention device of compact design creates large advantages.

A favorable option provides that the hydrocarbon retention device only has filter membranes for separating the hydrocarbons from air. This means in particular that the hydrocarbon retention device does not have any activated carbon filters or other adsorbing materials. This means that the hydrocarbon retention devices can be realized solely by using a filter membrane of this type, which provides for a very simple and cost-efficient setup.

A further favorable option provides that at least one filter membrane has graphene. Membranes of this type, which contain graphene, can be designed to be very thin due to the high stability of the graphene. They can furthermore be provided with defined pore sizes, which provide for the selection between the air components and the hydrocarbons of the fuel.

An advantageous option provides that at least one filter membrane has hydrocarbon nanotubes. These hydrocarbon nanotubes provide for a reinforcement of the membrane, in particular due to the fibrous structure of the hydrocarbon nanotubes and the extremely high stability of the hydrocarbon nanotubes, so that the gas flow rate of air components through the membrane is very high and only a smaller membrane surface is thus required.

A further advantageous option provides that at least one filter membrane has hydrophilized, strongly cross-linked solvent-stable polymeric membranes. On the one hand, membranes of this type are chemically resistant to the fuel, so that they are not attacked. Due to the hydrophilization, on the other hand, they are strongly repellent to nonpolar molecules, as they usually occur in fuels. As a result, filter membranes of this type have a high selectivity.

A favorable alternative provides that the filter membrane has pores, which have a defined pore size, by means of which it is made possible that fuel molecules are retained and air molecules can pass through the membrane through the pores of the membrane. This provides for the production of filter membranes, which have a very high selectivity between the hydrocarbons and the air components. Membranes of this type furthermore have a very high retention potential for the hydrocarbons.

In the description and the enclosed claims, air molecules are in particular understood to be molecules, which are typically contained in the air, in particular oxygen, nitrogen, and carbon dioxide. In addition, further air components are argon, which, due to the atomic gaseous form, is smaller than CO2 molecules and can thus likewise pass through the membrane without any problems.

An advantageous option provides that the at least one filter membrane is a gas permeation membrane with a high selective permeability. Membranes of this type have substance-related solubilities and diffusion coefficients, so that the permeation can vary in strength, depending on the substance. Membranes of this type can in particular be formed in such a way that hydrocarbons have a very low permeability, while small molecules, as they can be found in the air, for example, thus oxygen, nitrogen, and CO₂, have a high permeability. As a result, a selective retention of the hydrocarbons can likewise be made possible with the help of a filter membrane of this type. In the alternative, gas permeation membranes of this type can have a high permeability for hydrocarbons and a low permeability for the air components, so that the separation of air and fuel is effected by the retention of the air components.

A further particularly advantageous option provides that a flow generation device is provided, which drives a gas mixture, which is located in the fuel tank, so that the gas mixture flows along the filter membrane at least in some sections. As a result, a so-called crossflow filtration process is provided. The flow of the gas along the membrane provides for a consistent concentration on the inside of the membrane, so that an effective exchange of the air components is possible. As a result, it is in particular avoided that the concentration of the air relative to the hydrocarbon vapors changes at the membrane, at which the air molecules can diffuse through the membrane, and would thus influence the filtration properties of the filter membrane.

Further important features and advantages of the invention follow from the subclaims, from the drawings, and from the corresponding figure description on the basis of the drawings.

It goes without saying that the above-mentioned features and the features, which will be described below, cannot only be used in the respective specified combination, but also in other combinations or alone, without leaving the scope of the present invention.

Preferred exemplary embodiments of the invention are illustrated in the drawings and will be described in more detail in the following description, whereby identical reference numerals refer to identical or similar or functionally identical components.

### BRIEF DESCRIPTION OF THE DRAWINGS

In each case schematically,

FIG. 1 shows a schematic illustration of a first embodiment of a fuel supply system,

FIG. 2 shows a schematic diagram of a second embodiment of a fuel supply system,

FIG. 3 shows a schematic diagram of a hydrocarbon retention device of the fuel supply system from FIG. 2, and

FIG. 4 shows a schematic diagram of a hydrocarbon retention device of a fuel supply system according to a third embodiment.

### DETAILED DESCRIPTION

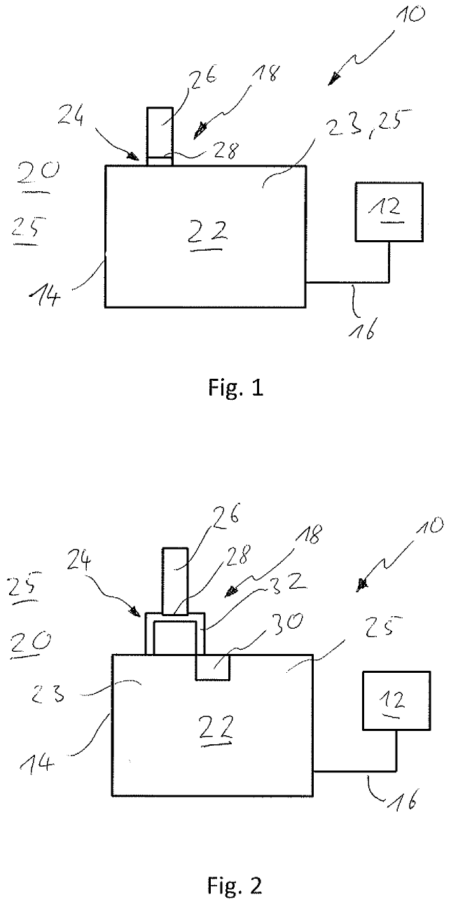

A first embodiment of a fuel supply system 10 for an internal combustion engine 12 illustrated in FIG. 1 can be used, for example, in a motor vehicle, which is driven by means of this internal combustion engine 12, in order to provide fuel for the internal combustion engine. The fuel supply system has a fuel tank 14, in which the fuel for the internal combustion engine 12 can be stored. In addition, at least one fuel line 16 is provided, via which fuel can be guided to the internal combustion engine 12.

In order to facilitate the filling and emptying of the fuel tank 14, an air supply and venting device 18 is provided, by means of which gas, in particular air 25 between the environment 20 and an interior space 22 of the fuel tank 14 can be exchanged. Due to the air supply and venting device 18, a pressure compensation can take place in the interior space 22 of the fuel tank 14, so that fuel can be removed from the tank via the fuel line 16 without any problems. This likewise facilitates the filling of the fuel tank 14.

In order to prevent that the fuel, in particular the fuel vapors 23, can escape via the air supply and venting device 18 into the environment 20, a hydrocarbon retention device 24 is provided, which is arranged in an air supply and venting path 26 of the air supply and venting device 18.

The hydrocarbon retention device 24 thereby has a filter membrane 28, which is arranged in such a way that it completely closes the air supply and venting path 26. As a result, the gas, which is exchanged between the interior space 22 and the environment 20 by means of the air supply and venting device 18, has to pass through the filter membrane 28. The filter membrane 28 is thereby formed in such a way that it selectively retains hydrocarbons 23, that is, hydrocarbons 23 cannot pass through the filter membrane 28 or can pass through only very poorly, so that hydrocarbons 23 cannot escape into the environment 20 via the air supply and venting path 26.

Filter membranes 28 of this type can have, for example, several pores, which, due to the pore size, provide for a selection between large and small molecules. Due to the selection of the pore size, a selection can thus be made between the hydrocarbons 23, which are present in the fuel, and the molecules and atoms, which are typically present in particular in the air 25. The main components of the air 25, oxygen, nitrogen, and carbon dioxide, are in particular small compared to the hydrocarbon chains 23, which are usually present in gasoline or diesel.

Membranes of this type for the filter membrane 28 can further have graphene, which provides for a particularly high stability of the filter membrane 28. As a result, the pore size or particularly stable pores can furthermore be created systematically.

It is further possible that the filter membrane 28 has hydrocarbon nanotubes. These hydrocarbon nanotubes can likewise increase the stability of the filter membrane 28, so that the latter can be formed to be thinner as a whole. As a result, the gas exchange for the air particles 25 can be increased with consistent retention capacity for the hydrocarbons 23. In particular the surface of the filter membrane 28 can thus be reduced.

The filter membrane 28 can further have hydrophilized, strongly cross-linked solvent-stable polymers. Polymers of this type also have a high selectivity and retention capacity for the hydrocarbons 23.

Finally, it is also conceivable that the filter membrane 28 is a gas permeation membrane with high selective permeability. This means that the permeability for in particular the air components 25, such as oxygen, nitrogen, and CO2, is much higher than the permeability of the hydrocarbons 23 of the fuel. This can be attained, for example, by means of a different solubility and different diffusion coefficients for the air components 25 and or the hydrocarbon atoms 23, respectively.

A second embodiment of the fuel supply system 10 illustrated in FIG. 2 differs from the first embodiment of the fuel supply system illustrated in FIG. 1 in that a flow generating device 30 is provided, which drives the gas mixture, which is present in the interior space 22 of the fuel tank 14, in such a way that the gas mixture flows along the filter membrane 28 at least in some sections. As a result, a so-called “crossflow process” is at hand. As a result, concentration shifts at the filter membrane 28 can be prevented, so that a long-lasting consistent filtration effect or retention effect, respectively, for the hydrocarbons 23 is at hand.

For example, a flow channel 32 can be provided, in which the flow generating device 30 introduces the gas mixture from the interior space 22 of the fuel tank 14. The filter membrane 28 can cover an opening 34 between the flow channel 32 and the air supply and venting path 26. In the alternative or in addition, the filter membrane 28 can be wound cylindrically, so that a large filter surface is available. As a result, the gas mixture is guided past the filter membrane 28 along the flow channel, so that the “crossflow process” is made possible.

In the alternative, the flow generating device 30 can be formed in that fresh air 25 is sucked in from the environment via the filter membrane 28 to the engine when the engine is started, and the hydrocarbons 23 accumulated in the flow channel 32 are thus used for the combustion.

Apart from that, the second embodiment of the fuel supply system 10 illustrated in FIG. 2 corresponds to the first embodiment of the fuel supply system 10 illustrated in FIG. 1 with regard to setup and function, to the above description of which reference is made in this respect.

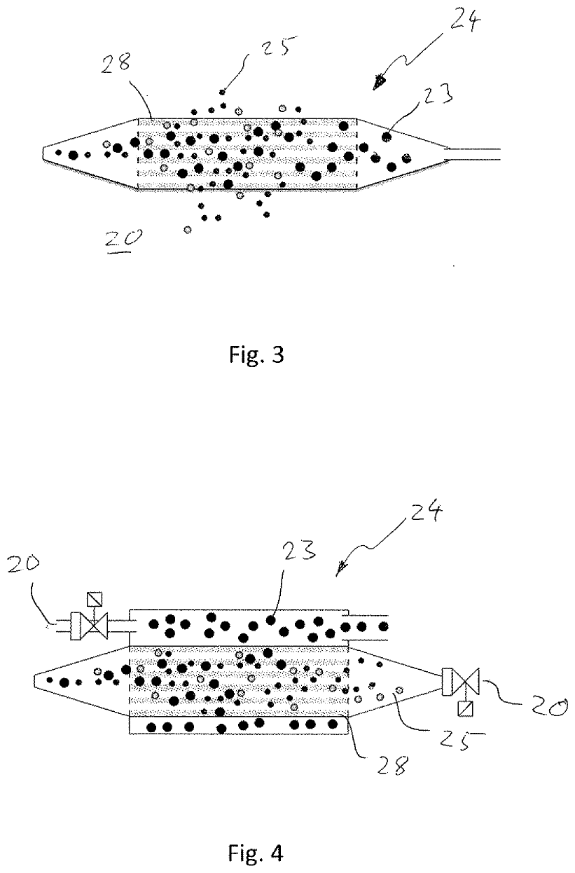

A third embodiment of the fuel supply system illustrated in FIG. 4 differs from the second embodiment of the fuel supply system 10 illustrated in FIGS. 2 and 3 in that the filter membrane 28 is formed in such a way that the filter membrane 28 is permeable for hydrocarbons 23, but largely retains the air components 25. As a result, the hydrocarbons 23 can likewise be separated from the air components 25.

Apart from that, the third embodiment of the fuel supply system illustrated in FIG. 4 corresponds to the second embodiment of the fuel supply system 10 illustrated in FIGS. 2 and 3 with regard to setup and function, to the above description of which reference is made in this respect.

1.-11. (canceled)

12. A fuel supply system for an internal combustion engine, comprising;
a fuel tank and an air supply and venting device for the fuel tank, wherein the air supply and venting device includes a hydrocarbon retention device;
the air supply and venting device including an air supply and venting path, structured and arranged to provide a gas exchange between the fuel tank and an environment,
the hydrocarbon retention device including at least one filter membrane that separates hydrocarbons from air,
wherein the at least one filter membrane is arranged in the air supply and venting path of the fuel tank such that the air supply and venting path is covered by the at least one filter membrane and prevents hydrocarbons from escaping from the fuel tank into the environment through the air supply and venting path; and
wherein the at least one filter membrane has hydrocarbon nanotubes.

13. The fuel supply system according to claim 1, wherein the hydrocarbon retention device only has filter membranes for separating the hydrocarbons from air.

14. The fuel supply system according to claim 1, wherein the at least one filter membrane has graphene.

15. The fuel supply system according to claim 1, wherein the at least one filter membrane has hydrophilized, strongly cross-linked solvent-stable polymeric membranes.

16. The fuel supply system according to claim 1, wherein the at least one filter membrane has pores with a defined pore size such that fuel molecules are retained and air molecules can pass through the at least one filter membrane through the pores of the at least one filter membrane.

17. The fuel supply system according to claim 1, wherein the at least one filter membrane is a gas permeation membrane with a high selective permeability.

18. The fuel supply system according to claim 1, further comprising a flow generation device that drives a gas mixture, the flow generation device located in the fuel tank such that the gas mixture flows along the at least one filter membrane at least in some sections.

19. The fuel supply system according to claim 1, wherein at least one of:
the at least one filter membrane is structured to retain hydrocarbons; and
the at least one filter membrane is structured to retain air components.

20. An internal combustion engine for a motor vehicle, comprising: a fuel supply system, the fuel supply system including:
a fuel tank and an air supply and venting device for the fuel tank, wherein the air supply and venting device includes a hydrocarbon retention device;
the air supply and venting device including an air supply and venting path, structured and arranged to provide a gas exchange between the fuel tank and an environment;
the hydrocarbon retention device including at least one filter membrane that separates hydrocarbons from air,
wherein the at least one filter membrane is arranged in the air supply and venting path of the fuel tank such that the air supply and venting path is covered by the at least one filter membrane and prevents hydrocarbons from escaping from the fuel tank into the environment through the air supply and venting path; and
wherein the at least one filter membrane has hydrocarbon nanotubes.

21. The internal combustion engine according to claim 20, wherein the hydrocarbon retention device only has filter membranes for separating the hydrocarbons from air.

22. The internal combustion engine according to claim 20, wherein the at least one filter membrane has graphene.

23. The internal combustion engine according to claim 20, wherein the at least one filter membrane has hydrophilized, strongly cross-linked solvent-stable polymeric membranes.

24. The internal combustion engine according to claim 20, wherein the at least one filter membrane has pores with a defined pore size such that fuel molecules are retained and air molecules can pass through the at least one filter membrane through the pores of the at least one filter membrane.

25. The internal combustion engine according to claim 20, wherein the at least one filter membrane is a gas permeation membrane with a high selective permeability.

26. The internal combustion engine according to claim 20, further comprising a flow generation device that drives a gas mixture, the flow generation device located in the fuel tank such that the gas mixture flows along the at least one filter membrane at least in some sections.

27. The internal combustion engine according to claim 20, wherein the at least one filter membrane is structured to retain hydrocarbons.

28. The internal combustion engine according to claim 20, wherein the at least one filter membrane is formed to retain air components.

29. A motor vehicle, comprising: an internal combustion engine, the internal combustion engine including:
a fuel supply system, the fuel supply system including:
a fuel tank and an air supply and venting device for the fuel tank, wherein the air supply and venting device includes a hydrocarbon retention device;
the air supply and venting device including an air supply and venting path, structured and arranged to provide a gas exchange between the fuel tank and an environment;
the hydrocarbon retention device including at least one filter membrane that separates hydrocarbons from air,
wherein the at least one filter membrane is arranged in the air supply and venting path of the fuel tank such that the air supply and venting path is covered by the at least one filter membrane and prevents hydrocarbons from escaping from the fuel tank into the environment through the air supply and venting path; and
wherein the at least one filter membrane has hydrocarbon nanotubes.

30. The motor vehicle according to claim 29, wherein the at least one filter membrane has graphene.

31. The motor vehicle according to claim 29, wherein the at least one filter membrane has hydrophilized, strongly cross-linked solvent-stable polymeric membranes.
